(19) United States
(12) Patent Application Publication
(10) Pub. No.: US 2020/0195619 A1
(43) Pub. Date: Jun. 18, 2020

(54) ON-VEHICLE COMMUNICATION DEVICE, ON-VEHICLE COMMUNICATION SYSTEM, SYNCHRONIZATION PROCESSING METHOD, AND RECORDING MEDIUM

(71) Applicants: Sumitomo Electric Industries, Ltd., Osaka-shi (JP); AutoNetworks Technologies, Ltd., Yokkaichi (JP); Sumitomo Wiring Systems, Ltd., Yokkaichi (JP)

(72) Inventors: Akihito IWATA, Osaka-shi (JP); Takeshi HAGIHARA, Yokkaichi (JP); Yasuhiro YABUUCHI, Yokkaichi (JP)

(73) Assignees: Sumitomo Electric Industries, Ltd., Osaka-shi (JP); AutoNetworks Technologies, Ltd., Yokkaichi (JP); Sumitomo Wiring Systems, Ltd., Yokkaichi (JP)

(21) Appl. No.: 16/614,899

(22) PCT Filed: Feb. 20, 2018
(86) PCT No.: PCT/JP2018/005994

§ 371 Date: Nov. 19, 2019

(30) Foreign Application Priority Data
May 19, 2017 (JP) 2017-099575

(51) Int. Cl. H04L 29/06; H04L 9/12

(52) U.S. Cl. CPC H04L 63/0428; H04L 9/12

(57) ABSTRACT

The on-vehicle communication device is an on-vehicle communication device to be mounted on a vehicle and is provided with: a storage unit configured to store a first encryption time that is a time required for encryption of data in another on-vehicle communication device, and a first decryption time that is a time required for decryption of data in the on-vehicle communication device itself; and a synchronization processing unit configured to perform synchronization processing of carrying out time synchronization of the on-vehicle communication device itself with the another on-vehicle communication device on the basis of the first encryption time and the first decryption time.

### CROSS-REFERENCE TO RELATED APPLICATIONS

This application is the national phase under 35 U.S.C. § 371 of PCT International Application No. PCT/JP2018/005994 which has an International filing date of Feb. 20, 2018 and designated the United States of America.

### FIELD

The present disclosure relates to an on-vehicle communication device, an on-vehicle communication system, a synchronization processing method, and a recording medium.

This application claims priority on Japanese Patent Application No. 2017-99575 filed on May 19, 2017, the entire contents of which are hereby incorporated.

### BACKGROUND

Japanese Patent Application Laid-Open No. 2013-168865 discloses the following on-vehicle network system.

That is, the on-vehicle network system is provided with: an on-vehicle control device including a memory configured to store definition data that defines a part conforming to installation on an on-vehicle network in a protocol to be used on the on-vehicle network; and a protocol issuing device configured to issue the definition data to the on-vehicle control device. When receiving a registration request that requests to allow the on-vehicle control device to join the on-vehicle network from a registration device that allows the on-vehicle control device to join the on-vehicle network, the protocol issuing device authenticates the registration device, and then creates the definition data conforming to installation on the on-vehicle network and transmits the definition data back to the registration device. The registration device receives the definition data transmitted by the protocol issuing device, and requests the on-vehicle control device to store the received definition data in the memory. In addition, the on-vehicle control device receives definition data from the registration device, stores the definition data in the memory, and performs communication using the on-vehicle network in conformity to the protocol according to the part defined by the definition data.

### SUMMARY

(1) An on-vehicle communication device of the present disclosure is an on-vehicle communication device to be mounted on a vehicle and is provided with: a storage unit configured to store a first encryption time that is a time required for encryption of data in another on-vehicle communication device, and a first decryption time that is a time required for decryption of data in the on-vehicle communication device itself; and a synchronization processing unit configured to perform synchronization processing of carrying out time synchronization of the on-vehicle communication device itself with the another on-vehicle communication device on the basis of the first encryption time and the first decryption time.

(10) An on-vehicle communication system of the present disclosure is provided with a first on-vehicle communication device to be mounted on a vehicle, and a second on-vehicle communication device to be mounted on the vehicle, and the second on-vehicle communication device stores a first encryption time that is a time required for encryption of data in the first on-vehicle communication device, and a first decryption time that is a time required for decryption of data in the second on-vehicle communication device itself, and performs synchronization processing of carrying out time synchronization of the second on-vehicle communication device itself with the first on-vehicle communication device on the basis of the first encryption time and the first decryption time.

(11) A synchronization processing method of the present disclosure is a synchronization processing method in an on-vehicle communication device, which is an on-vehicle communication device to be mounted on a vehicle and is provided with a storage unit configured to store a first encryption time that is a time required for encryption of data in another on-vehicle communication device and a first decryption time that is a time required for decryption of data in the on-vehicle communication device itself, the synchronization processing method including: a step of acquiring the first encryption time and the first decryption time from the storage unit; and a step of performing synchronization processing of carrying out time synchronization of the on-vehicle communication device itself with the another on-vehicle communication device on the basis of the acquired first encryption time and the acquired first decryption time.

(12) A synchronization processing method of the present disclosure is a synchronization processing method in an on-vehicle communication system provided with a first on-vehicle communication device to be mounted on a vehicle and a second on-vehicle communication device to be mounted on the vehicle, the second on-vehicle communication device storing a first encryption time that is a time required for encryption of data in the first on-vehicle communication device and a first decryption time that is a time required for decryption of data in the second on-vehicle communication device itself, the synchronization processing method including: a step of acquiring the first encryption time and the first decryption time by the second on-vehicle communication device; and a step of performing synchronization processing of carrying out time synchronization of the second on-vehicle communication device itself with the first on-vehicle communication device by the second on-vehicle communication device on the basis of the acquired first encryption time and the acquired first decryption time.

(13) A computer readable non-transitory recording medium of the present disclosure is a computer readable non-transitory recording medium recording a synchronization processing program to be used in an on-vehicle communication device, which is an on-vehicle communication device to be mounted on a vehicle and is provided with a storage unit configured to store a first encryption time that is a time required for encryption of data in another on-vehicle communication device and a first decryption time that is a time required for decryption of data in the on-vehicle communication device itself, the synchronization processing program being capable of causing a computer to function as a synchronization processing unit configured to perform synchronization processing of carrying out time synchronization of the on-vehicle communication device itself with the another on-vehicle communication device on the basis of the first encryption time and the first decryption time.

An aspect of the present disclosure can be implemented as a semiconductor integrated circuit that implements a part or the whole of an on-vehicle communication device.

An aspect of the present disclosure can also be implemented as a semiconductor integrated circuit that implements a part or the whole of an on-vehicle communication system.

The above and further objects and features of the invention will more fully be apparent from the following detailed description with accompanying drawings.

### BRIEF DESCRIPTION OF THE DRAWINGS

FIG. 1 is a view illustrating the configuration of an on-vehicle communication system according to an embodiment of the present disclosure.

FIG. 2 is a view illustrating an example of a vehicle control system to which an on-vehicle communication system according to an embodiment of the present disclosure is applied.

FIG. 3 is a view illustrating a comparative example of a sequence for performing synchronization processing by a slave device in an on-vehicle communication system according to an embodiment of the present disclosure.

FIG. 4 is a view illustrating a comparative example of a sequence for performing synchronization processing by a slave device in an on-vehicle communication system according to an embodiment of the present disclosure.

FIG. 5 is a view illustrating the configuration of a master device in an on-vehicle communication system according to an embodiment of the present disclosure.

FIG. 6 is a view illustrating the configuration of a slave device in an on-vehicle communication system according to an embodiment of the present disclosure.

FIG. 7 is a view illustrating an example of a sequence for performing synchronization processing by a slave device in an on-vehicle communication system according to an embodiment of the present disclosure.

FIG. 8 is a view illustrating an example of a sequence for performing synchronization processing by a slave device in an on-vehicle communication system according to an embodiment of the present disclosure.

Conventionally, an on-vehicle network system for improving security of an on-vehicle network has been developed.

### Technical Problems

With the aim of improving security of an on-vehicle network described in Japanese Patent Application Laid-Open No. 2013-168865, data to be transferred in the on-vehicle network is sometimes encrypted, for example.

In such a configuration, encryption processing of data is performed in a device that transmits data, while decryption processing is performed in a device that receives data. In a case where time is synchronized between a device that transmits data and a device that receives data, it becomes difficult to carry out precise time synchronization between on-vehicle communication devices if a time for encryption processing and a time for decryption processing are not known even when a time required for transfer of data from a device that transmits data to a device that receives data is known, for example.

The present disclosures has been made in order to resolve the above problems, and an object thereof is to provide an on-vehicle communication device, an on-vehicle communication system, a synchronization processing method, and a synchronization processing program that can carry out further precise time synchronization in an on-vehicle network in which encrypted data is transferred.

It is possible with the present disclosure to carry out further precise time synchronization in an on-vehicle network in which encrypted data is transferred.

First, contents of embodiments of the present disclosure will be listed and described.

(1) An on-vehicle communication device according to an embodiment of the present disclosure is an on-vehicle communication device to be mounted on a vehicle and is provided with: a storage unit configured to store a first encryption time that is a time required for encryption of data in another on-vehicle communication device, and a first decryption time that is a time required for decryption of data in the on-vehicle communication device itself, and a synchronization processing unit configured to perform synchronization processing of carrying out time synchronization of the on-vehicle communication device itself with the another on-vehicle communication device on the basis of the first encryption time and the first decryption time.

With such a configuration that a storage unit holds a first encryption time that is a time required for encryption of data in another on-vehicle communication device and a first decryption time that is a time required for decryption of data in the on-vehicle communication device itself, it is possible to avoid a situation that a time for encryption processing in the another on-vehicle communication device and a time for decryption processing in the on-vehicle communication device itself cannot be obtained, and it is therefore possible to carry out further precise time synchronization of the on-vehicle communication device with the another on-vehicle communication device. Accordingly, it is possible to carry out further precise time synchronization in an on-vehicle network in which encrypted data is transferred.

(2) Preferably, the storage unit further stores a second encryption time that is a time required for encryption of data in the on-vehicle communication device itself, and a second decryption time that is a time required for decryption of data in the another on-vehicle communication device, and the synchronization processing unit performs the synchronization processing on the basis of the first encryption time, the first decryption time, the second encryption time, and the second decryption time.

It is possible with such a configuration to precisely calculate a difference between the transmission time of data in the another on-vehicle communication device and the reception time of the data in the on-vehicle communication device itself on the basis of the first encryption time and the first decryption time, and to precisely calculate a difference between the transmission time of data in the on-vehicle communication device itself and the reception time of the data in the another on-vehicle communication device on the basis of the second encryption time and the second decryption time, for example. This makes it possible to calculate a time required for transfer of data between the another on-vehicle communication device and the on-vehicle communication device itself further precisely.

(3) Preferably, the storage unit stores the first encryption time and the first decryption time according to the size of data.

A time required for encryption of data in the another on-vehicle communication device, and a time required for decryption of data in the on-vehicle communication device itself are considered to vary according to the size of data. In such a case, it is also possible with the above configuration to perform synchronization processing on the basis of the first encryption time and the first decryption time that are further precise and fit the size of data.

(4) More preferably, the storage unit stores the second encryption time and the second decryption time corresponding to the size of data.

A time required for encryption of data in the on-vehicle communication device itself, and a time required for decryption of data in the another on-vehicle communication device are considered to vary according to the size of data. In such a case, it is also possible with the above configuration to perform synchronization processing on the basis of the second encryption time and the second decryption time that are further precise and fit the size of data.

(5) Preferably, data to be transmitted from the another on-vehicle communication device to the on-vehicle communication device itself includes time information, and the synchronization processing unit performs the synchronization processing on the basis of the time information included in the data received from the another on-vehicle communication device, and the first encryption time and the first decryption time.

With such a configuration, the on-vehicle communication device itself can recognize data creation time including the time information, for example, on the basis of time information, and it is therefore possible to carry out further precise time synchronization of the on-vehicle communication device itself with the another on-vehicle communication device on the basis of the recognized creation time, and the first encryption time and the first decryption time.

(6) Preferably, any one of the another on-vehicle communication device and the on-vehicle communication device itself is a device configured to control equipment mounted on the vehicle.

It is possible with such a configuration to synchronize the time in a device configured to control equipment mounted on a vehicle with another on-vehicle communication device, or to synchronize the on-vehicle communication device with said device, and it is therefore possible to avoid deviation of control timing of said device due to not being synchronized of said device.

(7) Preferably, any one of the another on-vehicle communication device and the on-vehicle communication device itself is a device configured to detect an object around the vehicle.

It is possible with such a structure to synchronize the time in a device configured to detect an object around a vehicle with another on-vehicle communication device, or to synchronize the on-vehicle communication device itself with said device, and it is therefore possible to avoid erroneous determination in automatic drive due to imprecise detection timing in a case where detection timing of an object in said device is used for automatic drive control, for example.

(8) Preferably, the data includes information for controlling equipment mounted on the vehicle.

It is possible with such a configuration to encrypt information for controlling equipment mounted on a vehicle and transfer the information in an on-vehicle network, and it is therefore possible to perform synchronization processing while enhancing security of said information. This makes it possible to prevent incorrect control of equipment mounted on a vehicle.

(9) Preferably, the data includes information indicating a detection result of an object around the vehicle.

It is possible with such a configuration to encrypt information indicating the detection result of an object around a vehicle and transfer the information in an on-vehicle network, and it is therefore possible to perform synchronization processing while enhancing security of said information. This makes it possible to prevent a device for automatic drive from making an abnormal decision on the basis of an incorrect detection result, for example.

(10) An on-vehicle communication system according to an embodiment of the present disclosure is provided with a first on-vehicle communication device to be mounted on a vehicle, and a second on-vehicle communication device to be mounted on the vehicle, and the second on-vehicle communication device stores a first encryption time that is a time required for encryption of data in the first on-vehicle communication device, and a first decryption time that is a time required for decryption of data in the second on-vehicle communication device itself, and performs synchronization processing of carrying out time synchronization of the second on-vehicle communication device itself with the first on-vehicle communication device on the basis of the first encryption time and the first decryption time.

With such a configuration that the second on-vehicle communication device stores a first encryption time that is a time required for encryption of data in the first on-vehicle communication device and a first decryption time that is a time required for decryption of data in the second on-vehicle communication device, it is possible to avoid a situation that the time for encryption processing in the first on-vehicle communication device and the time for decryption processing in the second on-vehicle communication device cannot be obtained, and it is therefore possible to carry out further precise time synchronization of the second on-vehicle communication device with the first on-vehicle communication device. Accordingly, it is possible to carry out further precise time synchronization in an on-vehicle network in which encrypted data is transferred.

(11) A synchronization processing method according to an embodiment of the present disclosure is a synchronization processing method in an on-vehicle communication device, which is an on-vehicle communication device to be mounted on a vehicle and is provided with a storage unit configured to store a first encryption time that is a time required for encryption of data in another on-vehicle communication device and a first decryption time that is a time required for decryption of data in the on-vehicle communication device itself, the synchronization processing method including: a step of acquiring the encryption time and the first decryption time from the storage unit; and a step of performing synchronization processing of carrying out time synchronization of the on-vehicle communication device itself with the another on-vehicle communication device on the basis of the acquired first encryption time and the acquired first decryption time.

In such a configuration that the storage unit holds a first encryption time that is a time required for encryption of data in the another on-vehicle communication device and the first decryption time that is a time required for decryption of data in the on-vehicle communication device itself, it is possible to avoid a situation that the time for synchronization processing in the another on-vehicle communication device and the time for decryption processing in the on-vehicle communication device itself cannot be obtained, and it is therefore possible to carry out further precise time synchronization of the on-vehicle communication device itself with the another on-vehicle communication device. Accordingly, it is possible to carry out further precise time synchronization in an on-vehicle network in which encrypted data is transferred.

(12) A synchronization processing method according to an embodiment of the present disclosure is a synchronization processing method in an on-vehicle communication system provided with a first on-vehicle communication device to be mounted on a vehicle and a second on-vehicle communication device to be mounted on the vehicle, the second on-vehicle communication device storing a first encryption time that is a time required for encryption of data in the first on-vehicle communication device and a first decryption time that is a time required for decryption of data in the second on-vehicle communication device itself, the synchronization processing method including: a step of acquiring the first encryption time and the first decryption time by the second on-vehicle communication device; and a step of performing synchronization processing of carrying out time synchronization of the second on-vehicle communication device itself with the first on-vehicle communication device by the second on-vehicle communication device on the basis of the acquired first encryption time and the acquired first decryption time.

In such a configuration that the second on-vehicle communication device stores a first encryption time that is a time required for encryption of data in the first on-vehicle communication device and a first decryption time that is a time required for decryption of data in the second on-vehicle communication device, it is possible to avoid a situation that the time for encryption processing in the first on-vehicle communication device and the time for decryption processing in the second on-vehicle communication device cannot be obtained, and it is therefore possible to carry out further precise time synchronization of the second on-vehicle communication device with the first on-vehicle communication device. Accordingly, it is possible to carry out further precise time synchronization in an on-vehicle network in which encrypted data is transferred.

(13) A computer readable non-transitory recording medium according to an embodiment of the present disclosure is a computer readable non-transitory recording medium recording a synchronization processing program to be used in an on-vehicle communication device, which is an on-vehicle communication device to be mounted on a vehicle and is provided with a storage unit configured to store a first encryption time that is a time required for encryption of data in another on-vehicle communication device and a first decryption time that is a time required for decryption of data in the on-vehicle communication device itself, the synchronization processing program being capable of causing a computer to function as a synchronization processing unit configured to perform synchronization processing of carrying out time synchronization of the on-vehicle communication device itself with the another on-vehicle communication device on the basis of the first encryption time and the first decryption time.

In such a configuration that the storage unit holds a first encryption time that is a time required for encryption of data in the another on-vehicle communication device and a first decryption time that is a time required for decryption of data in the on-vehicle communication device itself, it is possible to avoid a situation that the time for encryption processing in the another on-vehicle communication device and the time for decryption processing in the on-vehicle communication device itself, and it is therefore possible to carry out further precise time synchronization of the on-vehicle communication device itself with the another on-vehicle communication device. Accordingly, it is possible to carry out further precise time synchronization in an on-vehicle network in which encrypted data is transferred.

The following description will explain embodiments of the present disclosure with reference to the drawings. It is to be noted that the same reference sings are attached to the same or corresponding parts in figures, and explanation thereof will not be repeated. Moreover, at least a part of embodiments that will be described hereinafter may be combined arbitrarily.

[Configuration and Basic Operation]

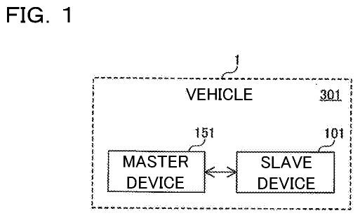

FIG. 1 is a view illustrating the configuration of an on-vehicle communication system according to an embodiment of the present disclosure.

Referring to FIG. 1, an on-vehicle communication system 301 is provided with a slave device (second on-vehicle communication device) 101 and a master device (first on-vehicle communication device) 151. The on-vehicle communication system 301 is mounted on a vehicle 1.

The slave device 101 and the master device 151 are examples of an on-vehicle communication device. The slave device 101 and the master device 151 each have a clock unit and measure time independently.

The slave device 101 performs synchronization processing of synchronizing the time of the slave device 101 itself with the time of the master device 151. This causes time synchronization between the slave device 101 and the master device 151.

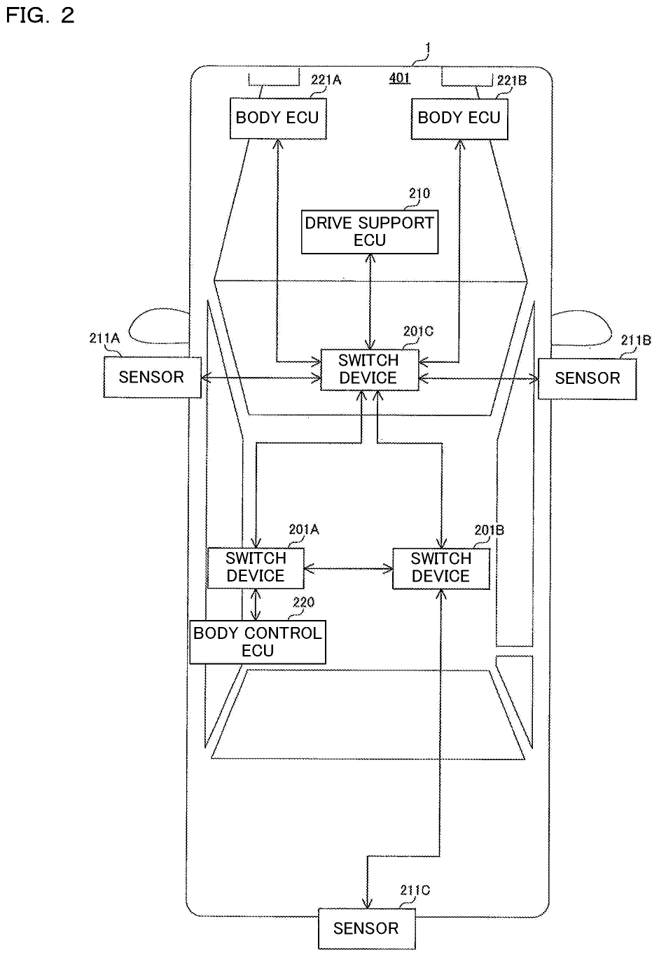

FIG. 2 is a view illustrating an example of an on-vehicle control system to which a vehicle communication system according to an embodiment of the present disclosure is applied.

Referring to FIG. 2, a vehicle control system 401 is provided with switch devices 201A, 201B, and 201C, a drive support ECU (Electronic Control Unit) 210, sensors 211A, 211B, and 211C, a body control ECU 220, and body ECUs 221A and 221B. The vehicle control system 401 is mounted on the vehicle 1.

In the following description, each of the switch devices 201A, 201B, and 201C will also be referred to as a switch device 201. Each of the sensors 211A, 211B, and 211C will also be referred to as a sensor 211. Each of the body ECUs 221A and 221B will also be referred to as a body ECU 221.

The switch devices 201, the drive support ECU 210, the sensors 211, the body control ECU 220, and the body ECUs 221 in the vehicle control system 401 are examples of an on-vehicle communication device. More specifically, these on-vehicle communication devices are examples of a slave device 101 and are also examples of a master device 151.

That is, in this example, an on-vehicle communication device can operate as a slave device 101 and can also operate as a master device 151. It is to be noted that an on-vehicle communication device may be configured to operate as any one of a slave device 101 and a master device 151.

In the vehicle control system 401, data is transmitted and received between on-vehicle communication devices. Concretely, Ethernet (registered trademark) frames are transmitted and received between on-vehicle communication devices in the vehicle control system 401 according to IEEE 802.3 communication standard, for example.

It is to be noted that the vehicle control system 401 may have a configuration that data is transmitted and received between on-vehicle communication devices not necessarily according to IEEE 802.3 communication standard but according to a communication standard such as CAN (Controller Area Network) (registered trademark), FlexRay (registered trademark), MOST (Media Oriented Systems Transport) (registered trademark), or LIN (Local Interconnect Network).

Each switch device 201 relays Ethernet frames to be exchanged between on-vehicle communication devices. Concretely, each switch device 201 relays Ethernet frames to be exchanged between the device support ECU 210 and a sensor 211. Each switch device 201 also relays Ethernet frames to be exchanged between the body control ECU 220 and a body ECU 221.

An Ethernet frame includes information indicating the detection result of an object around the vehicle 1, for example.

The sensors 211A, 211B, and 211C are detection devices configured to detect an object around the vehicle 1, for example. More specifically, the sensors 211A, 211B, and 211C are millimeter wave sensors, for example, which sense an object around their own vehicle 1 and create an Ethernet frame including sensor information indicating the sensing result.

The sensors 211A, 211B, and 211C attach a time stamp including time indicated by their own clock units to the created Ethernet frame, and transmit the Ethernet frame to the drive support ECU 210 via one or a plurality of switch devices 201, for example.

The drive support ECU 210 is an example of a device (which will also be also referred to as a mounted equipment control device hereinafter) configured to control equipment mounted on the vehicle 1, and acquires sensor information and a time stamp from a received Ethernet frame when receiving the Ethernet frame from the sensors 211A, 211B, and 211C.

The drive support ECU 210 recognizes the time when the sensing result indicated by the acquired sensor information was created from the acquired time stamp.

The drive support ECU 210 recognizes an object around the vehicle 1 at the time on the basis of sensing results which were created at substantially same times, and supports drive of its own vehicle 1 on the basis of the recognition result. Concretely, the drive support ECU 210 supports drive of the vehicle 1 by controlling the accelerator, the brake, the gear, the steering, and the like of its own vehicle 1, for example.

When clock units in the sensors 211A, 211B, and 211C are not synchronized with each other, for example, drive support is performed in the drive support ECU 210 on the basis of results sensed at different times. Accordingly, the clock units in the sensors 211A, 211B, and 221C are required to be synchronized with each other.

Any one of the master device 151 and the slave device 101 is a detection device, for example.

Concretely, when the drive support ECU 210 operates as a master device 151, for example, the switch device 201C operates as a slave device 101 and performs synchronization processing of synchronizing the time of the switch device 201C itself with the time of the drive support ECU 210.

Next, the switch device 201C operates as a master device 151, and the switch device 201B operates as a slave device 101, for example, so that the switch device 201B performs synchronization processing of synchronizing the time of the switch device 201B itself with the time of the switch device 201C.

The sensors 211A and 211B perform synchronization processing of synchronizing the time of the sensors 211A and 211B themselves with the time of the switch device 201C as with the switch device 201B.

Next, the switch device 201B operates as a master device 151, and the sensor 211C operates as a slave device 101, for example, so that the sensor 211C performs synchronization processing of synchronizing the time of the sensor 211C itself with the time of the switch device 201B.

In such a manner, it is possible to synchronize clock units in the drive support ECU 210, the sensor 211A, the sensor 211B, and the sensor 211C with each other.

It is to be noted that the present invention is not limited to a configuration that the sensors 211 synchronize the time of the sensors 211 themselves with the time of the drive support ECU 210, and the drive support ECU 210 may be configured to synchronize the time of the drive support ECU 210 itself with the time of the sensors 211, or the drive support ECU 210 and the sensors 211C may be configured to synchronize the time of the drive support ECU 210 and the sensor 211C themselves with the time of the switch devices 201.

The body ECUs 221A and 221B are examples of a mounted equipment control device and respectively control the left headlight and the right headlight under control by the body control ECU 220.

An Ethernet frame includes information for controlling equipment mounted on the vehicle 1, for example.

More specifically, the body control ECU 220 is an example of a mounted equipment control device and controls opening/closing of windows and doors, and turning on/off of the headlights, for example.

The body control ECU 220 creates an Ethernet frame including a light turn-on command, and control timing information indicating a time when the body ECUs 221A and 221B are to perform light turn-on control, for example.

The body control ECU 220 transmits the created Ethernet frame to the body ECUs 221A and 221B via one or a plurality of switch devices 201, for example.

When receiving an Ethernet frame from the body control ECU 220, the body ECUs 221A and 221B acquire control timing information and a light turn-on command from the received Ethernet frame.

The body ECUs 221A and 221B respectively turn on the left headlight and the right headlight in timing, with which a time indicated by a clock unit and a time indicated by control timing information accord with each other, according to the light turn-on command.

Moreover, the body control ECU 220 creates an Ethernet frame including a light turn-off command, and control timing information indicating a time when the body ECUs 221A and 221B are to perform light turn-off control, for example.

The body control ECU 220 transmits the created Ethernet frame to the body ECUs 221A and 221B via a plurality of switch devices 201, for example.

When receiving an Ethernet frame from the body control ECU 220, the body ECUs 221A and 221B acquire control timing information and a light turn-off command from the received Ethernet frame.

The body ECUs 221A and 221B respectively turn off the left headlight and the right headlight in timing, with which a time indicated by a clock unit and a time indicated by control timing information accord with each other, according to the light turn-off command.

In a case where clock units in the body ECUs 221A and 221B are not synchronized with each other, for example, the left headlight and the right headlight are turned on and off in different timings. In a case where clock units in the body control ECU 220 and the body ECUs 221 are not synchronized with each other, a case can possibly occur that timing indicated by control timing information has already passed in a body ECU 221 at a timing when the body control ECU 220 receives said control timing information. It is therefore required that clock units in the body control ECU 220, the body ECU 221A, and the body ECU 221B are synchronized with each other.

Any one of the master device 151 and the slave device 101 is a mounted equipment control device, for example.

Concretely, in a case where the body control ECU 220 operates as a master device 151, for example, the switch device 201A operates as a slave device 101, and the switch device 201A performs synchronization processing of synchronizing the time of the switch device 201A itself with the time of the body control ECU 220.

Next, the switch device 201A operates as a master device 151, and the switch device 201C operates as a slave device 101, for example, so that the switch device 201C performs synchronization processing of synchronizing the time of the switch device 201C itself with the time of the switch device 201A.

Next, the switch device 201C operates as a master device 151, and the body ECU 221A operates as a slave device 101, for example, so that the body ECU 221A performs synchronization processing of synchronizing the time of the body ECU 221A itself with the time of the switch device 201C.

The body ECU 221B performs synchronization processing of synchronizing the time of the body ECU 221B itself with the time of the switch device 201C as with the body ECU 221A.

In such a manner, clock units in the body control ECU 220, the body ECU 221A, and the body ECU 221B can be synchronized with each other.

It is to be noted that the present invention is not limited to a configuration that the body ECUs 221 synchronize the time of the body ECUs 221 themselves with the time of the body control ECU 220, and the body control ECU 220 may be configured to synchronize the time of the body control ECU 220 itself with the time of the body ECUs 221, or the body control ECU 220 and the body ECUs 221 may be configured to synchronize the time of the body control ECU 220 and the body ECUs 221 themselves with the time of the switch devices 201.

[Flow of Operation]

Each device in the on-vehicle communication system is provided with a computer, and an arithmetic processing unit such as a CPU in said computer reads a program including a part or the whole of steps of the following sequence diagram or flowchart from an unillustrated memory and executes the program. Programs of these devices can be respectively installed from outside. Programs of these devices can be respectively distributed in a state stored in a recording medium.

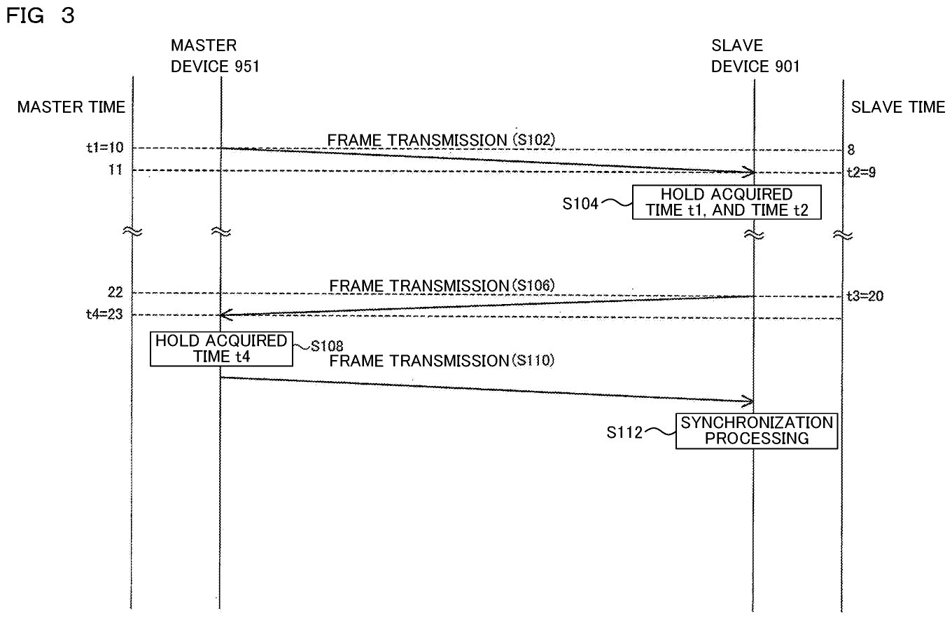

FIG. 3 is a view illustrating a comparison example of a sequence for performing synchronization processing by a slave device in an on-vehicle communication system according to an embodiment of the present disclosure.

Referring to FIG. 3, assume a situation that the time in a slave device 901 that is a comparison example of the slave device 101 is two seconds behind the time in a master device 951 that is a comparison example of the master device 151.

First, the master device 951 transmits an Ethernet frame including a time t1 that is a transmission timing based on time (which will also be referred to as master time hereinafter) indicated by a clock unit in the master device 951 itself, e.g. 10 seconds here, to the slave device 901 (step S102).

This Ethernet frame is transferred from the master device 951 to the slave device 901 in one second, for example.

Next, when receiving an Ethernet frame from the master device 951, the slave device 901 acquires a time t2 that is a reception timing based on time (which will also be referred to as slave time hereinafter) indicated by a clock unit in the slave device 901 itself, e.g. nine seconds here, and holds the acquired time t2, and the time t1 included in the Ethernet frame (step S104).

Next, the slave device 901 transmits the Ethernet frame to the master device 951 (step S106). Here, the slave device 901 holds a time t3 that is a transmission timing of said Ethernet frame based on the slave time, e.g. 20 seconds here.

This Ethernet frame is transferred from the slave device 901 to the master device 951 in one second, for example.

Next, when receiving an Ethernet frame from the slave device 901, the master device 951 acquires a time t4 that is a reception timing based on the master time, e.g. 23 seconds here, and holds the acquired time t4 (step S108).

Next, the master device 951 transmits an Ethernet frame including the held time t4 to the slave device 901 (step S110).

Next, when receiving an Ethernet frame from the master device 951, the slave device 901 performs synchronization processing on the basis of the held times t1, t2, and t3, and the time t4 included in the received Ethernet frame.

More specifically, the slave device 901 calculates an offset O between the master time and the slave time by substituting the times t1, t2, t3, and t4 into the following expression (1).

$$\begin{matrix}[ Mathematical 1 ] & \\ O = \frac{( t 2 - t 1 ) - ( t 4 - t 3 )}{2} & ( 1 )\end{matrix}$$

In this example, the slave device 901 calculates −2 as the offset O and subtracts the offset O from the slave time, so as to synchronize the time of the slave device 901 itself with the time of the master device 951.

[Problems]

An Ethernet frame to be transmitted and received between on-vehicle communication devices is sometimes encrypted in a vehicle control system 401.

More specifically, drive support of the vehicle 1, turn-on of the headlight, and the like are controlled incorrectly if the sensor information, the time stamp, the control timing information, the light turn-on command, and the light turn-off command are read incorrectly or rewritten incorrectly.

With the aim of preventing such incorrect control, Ethernet frames to be transmitted and received between on-vehicle communication devices are encrypted. In an encrypted Ethernet frame, a predetermined value is stored in a MACsec (MAC security) Ether type area, for example.

[Flow of Operation]

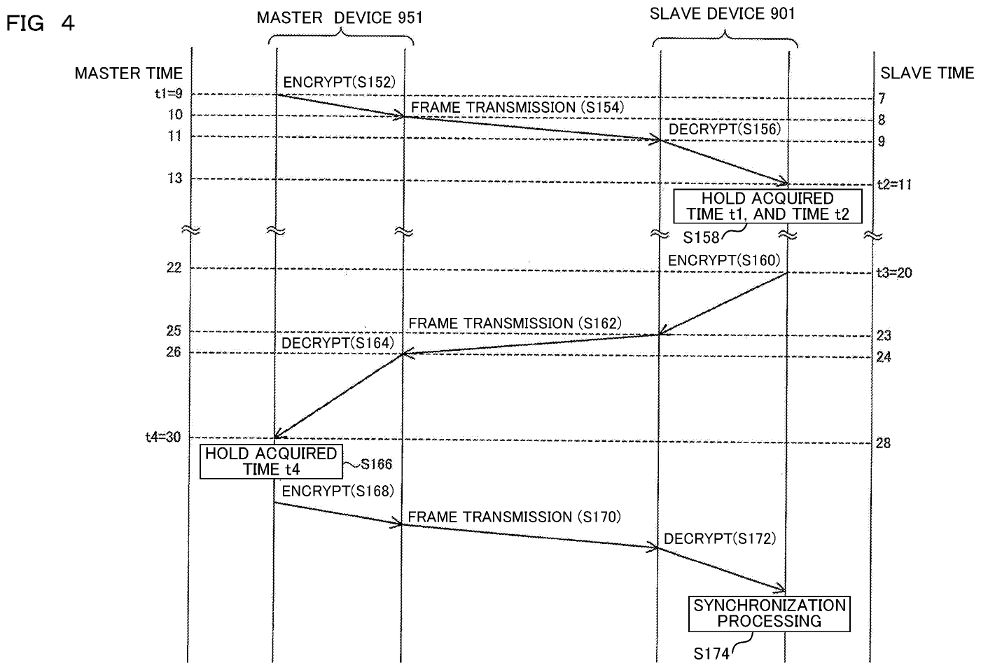

FIG. 4 is a view illustrating a comparative example of a sequence for performing synchronization processing by a slave device in an on-vehicle communication system according to an embodiment of the present disclosure.

Referring to FIG. 4, assume a situation that the time in the slave device 901 is two seconds behind the time in the master device 951.

First, the master device 951 encrypts an Ethernet frame including a time t1 that is a transmission timing based on the master time, e.g. nine seconds here (step S152).

A time (which will also be referred to as a first encryption time Em hereinafter) required for encryption of an Ethernet frame, i.e. data, in the master device 951 is one second, for example.

Next, the master device 951 transmits the encrypted Ethernet frame to the slave device 901 (step S154).

Next, when receiving an Ethernet frame from the master device 951, the slave device 901 decrypts the received Ethernet frame (step S156).

A time (which will also be referred to as a first decryption time Ds hereinafter) required for decryption of an Ethernet frame in the slave device 901 is two seconds, for example.

Next, the slave device 901 acquires a time t2 that is a reception timing of the decrypted Ethernet frame based on the slave time, e.g. 11 seconds here, and holds the acquired time t2, and the time t1 included in the Ethernet frame (step S158).

Next, the slave device 901 creates an Ethernet frame including predetermined information, for example, holds a time t3 that is a transmission timing based on the slave time, e.g. 20 seconds here, and encrypts said Ethernet frame (step S160).

A time (which will also be referred to as a second encryption time Es hereinafter) required for encryption of an Ethernet frame in the slave device 901 is three seconds, for example.

Next, the slave device 901 transmits the encrypted Ethernet frame to the master device 951 (step S162).

Next, when receiving an Ethernet frame from the slave device 901, the master device 951 decrypts the received Ethernet frame (step S164).

A time (which will also be referred to as a second decryption time Dm) required for decryption of an Ethernet frame in the master device 951 is four seconds, for example.

Next, the master device 951 acquires a time t4 that is a reception timing of the decrypted Ethernet frame based on the master time, e.g. 30 seconds here, and holds the acquired time t4 (step S166).

Next, the master device 951 encrypts an Ethernet frame including the held time t4 (step S168).

Next, the master device 951 transmits the encrypted Ethernet frame to the slave device 901 (step S170).

Next, when receiving an Ethernet frame from the master device 951, the slave device 901 decrypts the received Ethernet frame (step S172).

Next, the slave device 901 acquires the time t4 included in the decrypted Ethernet frame and performs synchronization processing on the basis of the acquired time t4, and the held times t1, t2, and t3.

Concretely, the slave device 901 substitutes the times t1, t2, t3, and t4 into the above expression (1) so as to calculate an offset O between the master time and the slave time.

However, in this example, the slave device 901 calculates −4 as the offset O, and therefore cannot synchronize the time of the slave device 901 itself with the time of the master device 951 by subtracting the offset O from the slave time.

In such a case, the time t1 acquired by the slave device 901 is not a time when the master device 951 actually transmitted the Ethernet frame but a time immediately before the master device 951 encrypted the Ethernet frame, which is different from the case illustrated in FIG. 3. Moreover, the time t2 acquired by the slave device 901 is not a time when the slave device 901 actually received the Ethernet frame but a time immediately after the slave device 901 decrypted the Ethernet frame, which is different from the case illustrated in FIG. 3.

Similarly, the time t3 acquired by the slave device 901 is not a time when the slave device 901 actually transmitted the Ethernet frame but is a time immediately before the slave device 901 encrypted the Ethernet frame. Moreover, the time t4 acquired by the slave device 901 is not a time when the master device 951 actually received the Ethernet frame but is a time immediately after the master device 951 decrypted the Ethernet frame.

That is, the slave device 901 does not acquire a time when the master device 951 actually transmits or receives an Ethernet frame and a time when the slave device 901 itself actually transmits or receives an Ethernet frame, and therefore calculates an erroneous offset O.

Consequently, an on-vehicle communication system according to an embodiment of the present disclosure resolves such a problem with the following configurations and operations.

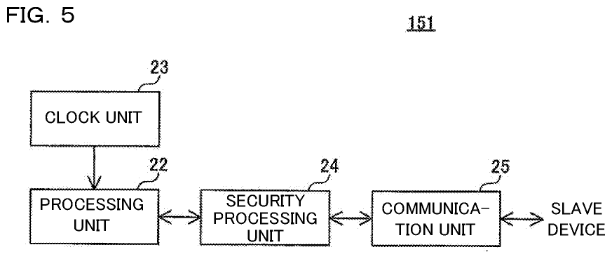

FIG. 5 is a view illustrating the configuration of a master device in an on-vehicle communication system according to an embodiment of the present disclosure.

Referring to FIG. 5, the master device 151 is provided with a processing unit 22, a clock unit 23, a security processing unit 24, and a communication unit 25. The clock unit 23 measures the master time.

The communication unit 25 communicates with a slave device 101. More specifically, when receiving an Ethernet frame from the slave device 101, the communication unit 25 outputs the received Ethernet frame to the security processing unit 24.

Moreover, when receiving an Ethernet frame from the security processing unit 24, the communication unit 25 transmits the received Ethernet frame to the slave device 101.

The security processing unit 24 encrypts and decrypts an Ethernet frame. More specifically, when receiving an Ethernet frame from the communication unit 25, the security processing unit 24 decrypts the received Ethernet frame according to a predetermined encryption standard, for example, and outputs the decrypted Ethernet frame to the processing unit 22. A time required for decryption of an Ethernet frame in the security processing unit 24 is the above-described second decryption time Dm.

Moreover, when receiving an Ethernet frame from the processing unit 22, the security processing unit 24 encrypts the received Ethernet frame according to a predetermined encryption standard, for example, and outputs the encrypted Ethernet frame to the communication unit 25. A time required for encryption of an Ethernet frame in the security processing unit 24 is the above-described first encryption time Em.

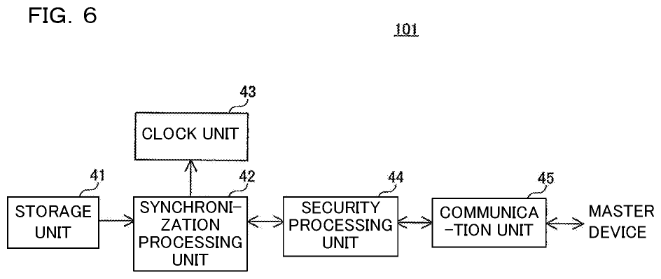

FIG. 6 is a view illustrating the configuration of a slave device in an on-vehicle communication system according to an embodiment of the present disclosure.

Referring to FIG. 6, the slave device 101 is provided with a storage unit 41, a synchronization processing unit 42, a clock unit 43, a security processing unit 44, and a communication unit 45. The clock unit 43 measures the slave time.

The communication unit 45 communicates with a master device 151. More specifically, when receiving an Ethernet frame from the master device 151, the communication unit 45 outputs the received Ethernet frame to the security processing unit 44.

Moreover, when receiving an Ethernet frame from the security processing unit 44, the communication unit 45 transmits the received Ethernet frame to the master device 151.

The security processing unit 44 encrypts and decrypts an Ethernet frame. More specifically, when receiving an Ethernet frame from the communication unit 45, the security processing unit 44 decrypts the received Ethernet frame according to a predetermined encryption standard, for example, and outputs the decrypted Ethernet frame to the synchronization processing unit 42. A time required for decryption of an Ethernet frame in the security processing unit 44 is the above-described first decryption time Ds.

Moreover, when receiving an Ethernet frame from the synchronization processing unit 42, the security processing unit 44 encrypts the received Ethernet frame according to a predetermined encryption standard, for example, and outputs the encrypted Ethernet frame to the communication unit 45. A time required for encryption of an Ethernet frame in the security processing unit 44 is the above-described second encryption time Es.

The storage unit 41 stores the first encryption time Em, the first decryption time Ds, the second encryption time Es, and the second decryption time Dm, for example.

More specifically, the storage unit 41 stores a first encryption time Em, a first decryption time Ds, a second encryption time Es, and a second decryption time Dm corresponding to the size of an Ethernet frame, for example.

The synchronization processing unit 42 performs synchronization processing on the basis of the first encryption time Em, the first decryption time Ds, the second encryption time Es, and the second decryption time Dm in the storage unit 41, for example.

[Flow of Operation]

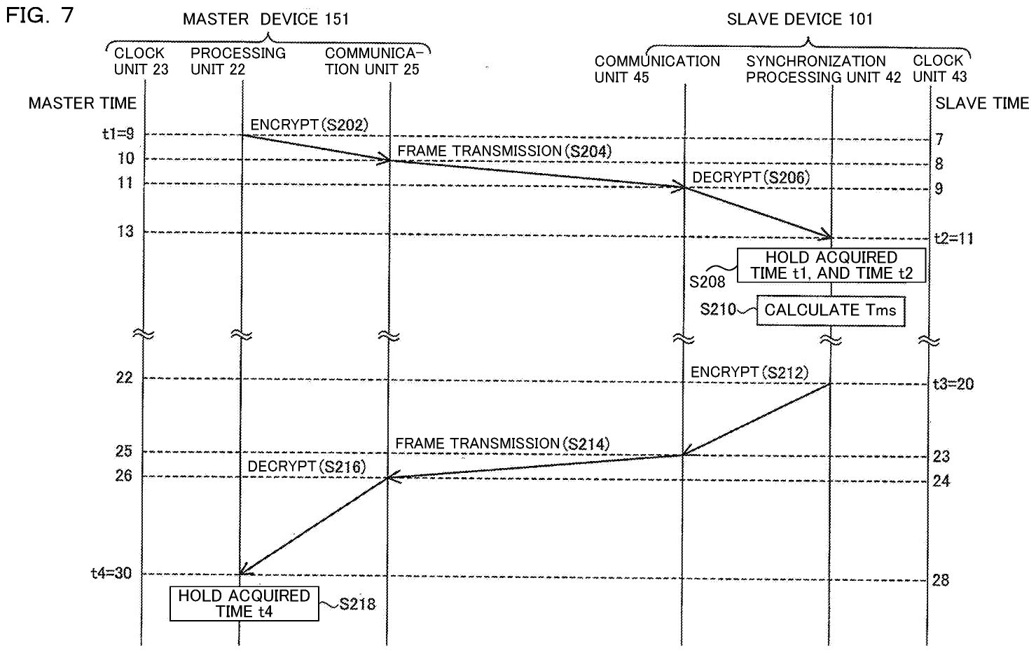

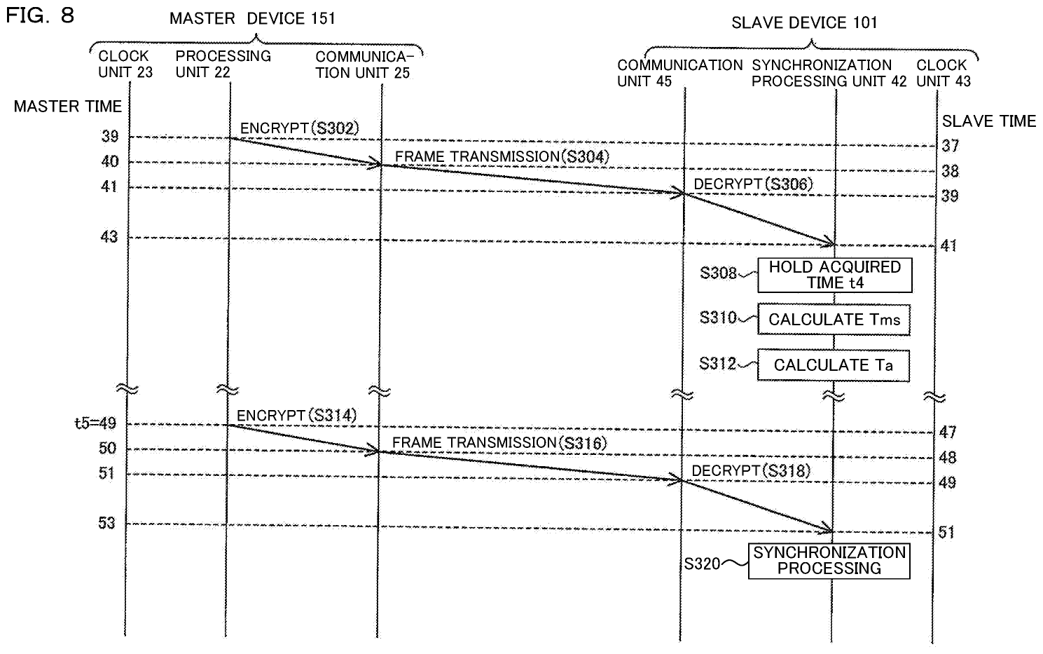

FIGS. 7 and 8 are a view illustrating an example of a sequence for performing synchronization processing by a slave device in an on-vehicle communication system according to an embodiment of the present disclosure. FIG. 8 is the continuation of the sequence in FIG. 7.

Referring to FIG. 7, assume a situation that the time in the slave device 101 is two seconds behind the time in the master device 151.

Moreover, assume that the first encryption time Em, the first decryption time Ds, the second encryption time Es, and the second decryption time Dm corresponding to the size of an Ethernet frame to be transmitted and received in this sequence are respectively one second, two seconds, three seconds, and four seconds.

The storage unit 41 stores one second, two seconds, three seconds, and four seconds respectively as the first encryption time Em, the first decryption time Ds, the second encryption time Es, and the second decryption time Dm corresponding to the size of an Ethernet frame to be transmitted and received in this sequence.

First, the master device 151 encrypts an Ethernet frame including a time t1 that is a transmission timing based on the master time, e.g. nine seconds here (step S202).

Specifically, an Ethernet frame to be transmitted from the master device 151 to the slave device 101 includes time information, for example.

More specifically, the processing unit 22 in the master device 151 creates time information indicated by the time t1 indicated by the clock unit 23 at a time when an Ethernet frame is to be transmitted, and outputs an Ethernet frame including the created time information to the security processing unit 24.

When receiving an Ethernet frame from the processing unit 22, the security processing unit 24 encrypts the received Ethernet frame in one second, for example, and outputs the encrypted Ethernet frame to the communication unit 25.

Next, the master device 151 transmits the encrypted Ethernet frame to the slave device 101 (step S204).

More specifically, when receiving an Ethernet frame from the security processing unit 24, the communication unit 25 transmits the received Ethernet frame to the slave device 101.

This Ethernet frame is transferred from the master device 151 to the slave device 101 in one second, for example.

Next, when receiving an Ethernet frame from the master device 151, the slave device 101 decrypts the received Ethernet frame (step S206).

More specifically, when receiving an Ethernet frame from the master device 151, the communication unit 45 in the slave device 101 outputs the received Ethernet frame to the security processing unit 44.

When receiving an Ethernet frame from the communication unit 45, the security processing unit 44 decrypts the received Ethernet frame in two seconds, for example, and outputs the decrypted Ethernet frame to the synchronization processing unit 42.

Next, the slave device 101 holds a time t2 that is a reception timing of the decrypted Ethernet frame based on the slave time, and a time t1 included in the Ethernet frame (step S208).

More specifically, when receiving an Ethernet frame from the security processing unit 44, the synchronization processing unit 42 acquires and holds a time indicated by the clock unit 43, e.g. 11 seconds here, as the time t2. The synchronization processing unit 42 also holds a time t1 indicated by time information included in the Ethernet frame received from the security processing unit 44.

Next, the slave device 101 calculates a transmission time Tms that is an apparent transmission time from the master device 151 to the slave device 101 (step S210).

More specifically, the synchronization processing unit 42 acquires the first encryption time Em and the first decryption time Ds corresponding to the Ethernet frame from the storage unit 41. Concretely, the synchronization processing unit 42 acquires one second and two seconds respectively as the first encryption time Em and the first decryption time Ds from the storage unit 41.

The synchronization processing unit 42 substitutes the held times t1 and t2, the acquired first encryption time Em, and the acquired first decryption time Ds into the following expression (2) so as to calculate the transmission time Tms.

[Mathematical 2]

Tms=t2−t1−(Em+Ds) (2)

Concretely, the synchronization processing unit 42 calculates and holds −1 as the transmission time Tms.

Next, the slave device 101 encrypts an Ethernet frame including predetermined information, for example, and holds a time t3 that is a transmission timing based on the slave time (step S212).

More specifically, the synchronization processing unit 42 creates an Ethernet frame including predetermined information, acquires and holds a time t3 indicated by the clock unit 43 at a time when said Ethernet frame is to be transmitted, e.g. 20 seconds here, and outputs said Ethernet frame to the security processing unit 44.

When receiving an Ethernet frame from the synchronization processing unit 42, the security processing unit 44 encrypts the received Ethernet frame in three seconds, for example, and outputs the encrypted Ethernet frame to the communication unit 45.

Next, the slave device 101 transmits the encrypted Ethernet frame to the master device 151 (step S214).

More specifically, when receiving an Ethernet frame from the security processing unit 44, the communication unit 45 transmits the received Ethernet frame to the master device 151.

This Ethernet frame is transferred from the slave device 101 to the master device 151 in one second, for example.

Next, when receiving an Ethernet frame from the slave device 101, the master device 151 decrypts the received Ethernet frame (step S216).

More specifically, when receiving an Ethernet frame from the slave device 101, the communication unit 25 in the master device 151 outputs the received Ethernet frame to the security processing unit 24.

When receiving an Ethernet frame from the communication unit 25, the security processing unit 24 decrypts the received Ethernet frame in four seconds, for example, and outputs the decrypted Ethernet frame to the processing unit 22.

Next, the master device 151 acquires a time t4 that is a reception timing of the decrypted Ethernet frame based on the master time, and holds the acquired time t4 (step S218).

More specifically, when receiving an Ethernet frame from the security processing unit 24, the processing unit 22 acquires and holds a time indicated by the clock unit 23, e.g. 30 seconds here, as the time T4.

Next, the master device 151 encrypts an Ethernet frame including the held time t4 (step S302).

More specifically, the processing unit 22 creates time information indicating the held time t4 at a timing when the master time is 39 seconds, and outputs an Ethernet frame including the created time information to the security processing unit 24.

When receiving an Ethernet frame from the processing unit 22, the security processing unit 24 encrypts the received Ethernet frame in one second, for example, and outputs the encrypted Ethernet frame to the communication unit 25.

Next, the master device 151 transmits the encrypted Ethernet frame to the slave device 101 (step S304).

Next, when receiving an Ethernet frame from the master device 151, the slave device 101 decrypts the received Ethernet frame (step S306).

Next, the slave device 101 acquires a time t4 included in the decrypted Ethernet frame and holds the acquired time t4 (step S308).

More specifically, when receiving an Ethernet frame from the security processing unit 44, the synchronization processing unit 42 in the slave device 101 holds a time t4 indicated by time information included in the received Ethernet frame.

Next, the slave device 101 calculates a transmission time Tsm that is an apparent transmission time from the slave device 101 to the master device 151 (step S310).

More specifically, the synchronization processing unit 42 acquires a second encryption time Es and a second decryption time Dm corresponding to the Ethernet frame from the storage unit 41. Concretely, the synchronization processing unit 42 acquires three seconds and four seconds respectively as the second encryption time Es and the second decryption time Dm from the storage unit 41.

The synchronization processing unit 42 substitutes the held times t3 and t4, the acquired second encryption time Es, and the acquired second decryption time Dm into the following expression (3) so as to calculate a transmission time Tsm.

[Mathematical 3]

Tsm=t4−t3−(Es+Dm) (3)

Concretely, the synchronization processing unit 42 calculates and holds 3 as the transmission time Tsm.

Next, the slave device 101 calculates an addition time Ta to be added to a synchronization reference time, which will be described later, to be synchronized with the master time (step S312).

More specifically, the synchronization processing unit 42 acquires the first encryption time Em and the first decryption time Ds from the storage unit 41 and substitutes the acquired first encryption time Em, the acquired first decryption time Ds, and the calculated transmission times Tms and Tsm into the following expression (4) so as to calculate an addition time Ta.

$$\begin{matrix}[ Mathematical 4 ] & \\ Ta = Em + Ds + \frac{Tms + Tms}{2} & ( 4 )\end{matrix}$$

Concretely, the synchronization processing unit 42 calculates and holds 4 as the addition time Ta.

Next, the master device 151 encrypts an Ethernet frame including a time t5 that is a transmission timing based on the master time, e.g. 49 seconds here, as a synchronization reference time (step S314).

More specifically, the processing unit 22 in the master device 151 creates synchronization reference time information indicating a time T5 indicated by the clock unit 23 at a time when the Ethernet frame is to be transmitted, and outputs an Ethernet frame including the created synchronization reference time information to the security processing unit 24.

When receiving an Ethernet frame from the processing unit 22, the security processing unit 24 encrypts the received Ethernet frame in one second, for example, and outputs the encrypted Ethernet frame to the communication unit 25.

Next, the master device 151 transmits the encrypted Ethernet frame to the slave device 101 (step S316).

Next, when receiving an Ethernet frame from the master device 151, the slave device 101 decrypts the received Ethernet frame (step S318).

Next, the slave device 101 performs synchronization processing (step S320).

Specifically, the synchronization processing unit 42 in the slave device 101 performs synchronization processing on the basis of the synchronization reference time information included in the Ethernet frame received from the master device 151, and the first encryption time Em and the second decryption time Dm, for example.

More specifically, the synchronization processing unit 42 acquires synchronization reference time information included in the decrypted Ethernet frame and performs synchronization processing on the basis of the acquired synchronization reference time information and the calculated addition time Ta.

Concretely, the synchronization processing unit 42 adds the addition time Ta to the time t5 indicated by the synchronization reference time information using the following expression (5) so as to calculate the time t6, and adjusts a time indicated by the clock unit 43 to the calculated time t6.

[Mathematical 5]

t6=t5+Ta (5)

More specifically, the synchronization processing unit 42 adds the addition time Ta, i.e. four seconds, to the time t5, i.e. 49 seconds, so as to calculate 53 seconds as the time t6, and adjusts a time indicated by the clock unit 43 to 53 seconds.

This makes it possible to synchronize the master time in the master device 151 and the slave time in the slave device 101 with each other.

Although the storage unit 41 in the slave device according to an embodiment of the present disclosure is configured to store the first encryption time Em, the first decryption time Ds, the second encryption time Es, and the second decryption time Dm, it is to be noted that the present invention is not limited to this. The storage unit 41 may be configured to store the first encryption time Em and the first decryption time Ds. In such a case, the synchronization processing unit 42 performs synchronization processing of carrying out time synchronization of its own slave device 101 with the master device 151 on the basis of the first encryption time Em and the first decryption time Ds stored in the storage unit 41. Concretely, the slave device 101 sometimes preliminarily measures (Tms+Tsm)/2 that is the mean value of the transmission times Tms and Tsm or has calculated said mean value in the last time synchronization processing. In such a case, the slave device 101 can calculate the addition time Ta using said mean value that has been already held, and therefore can perform synchronization processing on the basis of the addition time Ta, the first encryption time Em, and the first decryption time Ds.

Although the slave device according to an embodiment of the present disclosure has a configuration that the second encryption time Es and the second decryption time Dm are stored in the storage unit 41, the present invention is not limited to this configuration. The slave device may have a configuration that the second encryption time Es and the second decryption time Dm are stored in another device such as a master device 151 and are acquired by the synchronization processing unit 42 from said another device.

Moreover, although the storage unit 41 in the slave device according to an embodiment of the present disclosure is configured to store the first encryption time Em, the first decryption time Ds, the second encryption time Es, and the second decryption time Dm corresponding to the size of data, the present invention is not limited to this. The storage unit 41 may be configured to store the first encryption time Em, the first decryption time Ds, the second encryption time Es, and the second decryption time Dm that are fixed values. In a case where an Ethernet frame to be transferred in the on-vehicle communication system 301 has a fixed length, for example, the size of data to be encrypted and decrypted is fixed, and therefore the first encryption time Em, the first decryption time Ds, the second encryption time Es, and the second decryption time Dm become substantially constant. Moreover, the storage unit 41 may be configured to store any one of the first encryption time Em and the first decryption time Ds, and the second encryption time Es and the second decryption time Dm as fixed values and store the other as values corresponding to the size of data.

Moreover, although the on-vehicle communication system according to an embodiment of the present disclosure has a configuration that any one of the master device 151 and the slave device 101 is a mounted equipment control device or a detection device, the present invention is not limited to this configuration. The master device 151 and the slave device 101 may be not necessarily a mounted equipment control device or a detection device but a device such as a switch device 201.

Moreover, although the on-vehicle communication system according to an embodiment of the present disclosure has a configuration that an Ethernet frame includes information for controlling equipment mounted on the vehicle 1 or information indicating the detection result of an object around the vehicle 1, the present invention is not limited to this configuration. An on-vehicle communication system may have a configuration that an Ethernet frame does not include such information but includes time information or predetermined information, for example.

With the aim of improving security of an on-vehicle network described in Japanese Patent Application Laid-Open No. 2013-168865, data to be transferred in the on-vehicle network is sometimes encrypted, for example.

In such a configuration, encryption processing of data is performed in a device that transmits data, while decryption processing is performed in a device that receives data. In a case where time is synchronized between a device that transmits data and a device that receives data, it becomes difficult to carry out precise time synchronization between on-vehicle communication devices if a time for encryption processing and a time for decryption processing are not known even when a time required for transfer of data from a device that transmits data to a device that receives data is known, for example.

On the other hand, an on-vehicle communication device according to an embodiment of the present disclosure is mounted on a vehicle 1. The storage unit 41 stores a first encryption time Em that is a time required for encryption of data in another on-vehicle communication device, and a first decryption time Ds that is a time required for decryption of data in the on-vehicle communication device itself. In addition, the synchronization processing unit 42 performs synchronization processing of carrying out time synchronization of the on-vehicle communication device itself with the another on-vehicle communication device on the basis of the first encryption time Em and the first decryption time Ds.

With such a configuration that the storage unit 41 holds the first encryption time Em that is a time required for encryption of data in another on-vehicle communication device and a first decryption time Ds that is a time required for decryption of data in the on-vehicle communication device itself, it is possible to avoid a situation that the time for encryption processing in the another on-vehicle communication device and the time for decryption processing in the on-vehicle communication device itself cannot be obtained, and it is therefore possible to carry out further precise time synchronization of the on-vehicle communication device itself with the another on-vehicle communication device. Accordingly, it is possible to carry out further precise time synchronization in an on-vehicle network in which encrypted data is transferred.

Moreover, the storage unit 41 in an on-vehicle communication device according to an embodiment of the present disclosure further stores a second encryption time Es that is a time required for encryption of data in the on-vehicle communication device itself, and a second decryption time Dm that is a time required for decryption of data in the another on-vehicle communication device. In addition, the synchronization processing unit 42 performs synchronization processing on the basis of the first encryption time Em, the first decryption time Ds, the second encryption time Es, and the second decryption time Dm.

It is possible with such a configuration to precisely calculate a difference between the transmission time of data in the another on-vehicle communication device and the reception time of said data in the on-vehicle communication device itself on the basis of the first encryption time Em and the first decryption time Ds, and precisely calculate a difference between the transmission time of data in the on-vehicle communication device itself and the reception time of said data in the another on-vehicle communication device on the basis of the second encryption time Es and the second decryption time Dm, for example. This makes it possible to calculate a time required for transfer of data between the another on-vehicle communication device and the on-vehicle communication device itself further precisely.

Moreover, the storage unit 41 in an on-vehicle communication device according to an embodiment of the present disclosure stores the first encryption time Em and the first decryption time Ds corresponding to the size of data.

A time required for encryption of data in the another on-vehicle communication device, and a time required for decryption of data in the on-vehicle communication device itself are considered to vary according to the size of data. In such a case, the above configuration also makes it possible to perform synchronization processing on the basis of the first encryption time Em and the first decryption time Ds that are further precise and fit the size of data.

Moreover, the storage unit 41 in an on-vehicle communication device according to an embodiment of the present disclosure stores the second encryption time Es and the second decryption time Dm corresponding to the size of data.

A time required for encryption of data in the on-vehicle communication device itself, and a time required for decryption of data in the another on-vehicle communication device are considered to vary according to the size of data. In such a case, the above configuration also makes it possible to perform synchronization processing on the basis of the second encryption time Es and the second decryption time Dm that are further precise and fit the size of data.

Moreover, in an on-vehicle communication device according to an embodiment of the present disclosure, data to be transmitted from the another on-vehicle communication device to the on-vehicle communication device itself includes time information. In addition, the synchronization processing unit 42 performs synchronization processing on the basis of the time information included in data received from the another on-vehicle communication device, and the first encryption time Em and the first decryption time Ds.

With such a configuration, the on-vehicle communication device itself can recognize data creation time, which includes time information, for example, on the basis of said time information, and it is therefore possible carry out further precise time synchronization of the on-vehicle communication device itself with the another on-vehicle communication device on the basis of the recognized creation time, and the first encryption time Em and the first decryption time Ds.

Moreover, in an on-vehicle communication device according to an embodiment of the present disclosure, any one of the another on-vehicle communication device and the on-vehicle communication device itself is a device configured to control equipment mounted on the vehicle 1.

It is possible with such a configuration to synchronize the time in a device configured to control equipment mounted on the vehicle 1 with another on-vehicle communication device or synchronize the on-vehicle communication device itself with said device, and it is therefore possible to prevent deviation of control timing of said device due to not being synchronized of said device.

Moreover, in an on-vehicle communication device according to an embodiment of the present disclosure, any one of the another on-vehicle communication device and the on-vehicle communication device itself is a device configured to detect an object around the vehicle 1.

It is possible with such a configuration to synchronize the time in a device configured to detect an object around the vehicle 1 with the another on-vehicle communication device or synchronize the on-vehicle communication device itself with said device, and it is therefore possible to prevent erroneous determination in automatic drive due to imprecise detection timing in a case where detection timing of an object in said device is used for automatic drive control, for example.

Moreover, in an on-vehicle communication device according to an embodiment of the present disclosure, the above data includes information for controlling equipment mounted on the vehicle 1.

It is possible with such a configuration to encrypt information for controlling equipment mounted on the vehicle 1 and transfer the information in the on-vehicle network, and it is therefore possible to perform synchronization processing while enhancing security of said information. This makes it possible to prevent equipment mounted on the vehicle 1 from being controlled incorrectly.

Moreover, in an on-vehicle communication device according to an embodiment of the present disclosure, the above data includes information indicating the detection result of an object around the vehicle 1.

It is possible with such a configuration to encrypt information indicating the detection result of an object around the vehicle 1 and transfer the information in the on-vehicle network, and it is therefore possible to perform synchronization processing while enhancing security of said information. This makes it possible to prevent the drive support ECU 210 from erroneously determining on the basis of an incorrect detection result, for example.

Moreover, an on-vehicle communication system according to an embodiment of the present disclosure is provided with a master device 151 to be mounted on the vehicle 1, and a slave device 101 to be mounted on the vehicle 1. In addition, the slave device 101 stores a first encryption time Em that is a time required for encryption of data in the master device 151, and a first decryption time Ds that is a time required for decryption of data in the slave device 101 itself, and performs synchronization processing of carrying out time synchronization of the slave device 101 itself with the master device 151 on the basis of the first encryption time Em and the first decryption time Ds.

In such a configuration that the slave device 101 stores the first encryption time Em that is a time required for encryption of data in the master device 151 and the first decryption time Ds that is a time required for decryption of data in the slave device 101, it is possible to avoid a situation that the time for encryption processing in the master device 151 and the time for decryption processing in the slave device 101 cannot be obtained, and it is therefore possible to carry out further precise time synchronization of the slave device 101 with the master device 151. Accordingly, it is possible to carry out further precise time synchronization in an on-vehicle network in which encrypted data is transferred.

The above embodiments are to be considered illustrative in all aspects and not restrictive. The scope of the present disclosure is defined not by the above description but by the claims, and is intended to include meanings equivalent to the claims and all changes within the scope.

The above description includes the features in the following additional remarks.

[Additional Remark 1]

An on-vehicle communication device to be mounted on a vehicle, the on-vehicle communication device comprising:

a storage unit configured to store a first encryption time that is a time required for encryption of data in another on-vehicle communication device, and a first decryption time that is a time required for decryption of data in the on-vehicle communication device itself, and

a synchronization processing unit configured to perform synchronization processing of carrying out time synchronization of the on-vehicle communication device itself with the another on-vehicle communication device on the basis of the first encryption time and the first decryption time,

wherein the on-vehicle communication device is a switch device, a drive support ECU (Electronic Control Unit), a sensor, a body control ECU, or a body ECU,

the synchronization processing unit performs the synchronization processing on the basis of a mean time of a time required for transfer of data from the another on-vehicle communication device to the on-vehicle communication device itself and a time required for transfer of data from the on-vehicle communication device itself to the another on-vehicle communication device, and the first encryption time and the first decryption time, and

the on-vehicle communication device does not acquire a time when the another on-vehicle communication device transmits encrypted data, and a time when the on-vehicle communication device itself receives undecrypted data from the another on-vehicle communication device.

[Additional Remark 2]

An on-vehicle communication system comprising:

a first on-vehicle communication device to be mounted on a vehicle; and

a second on-vehicle communication device to be mounted on the vehicle,

wherein the second on-vehicle communication device stores a first encryption time that is a time required for encryption of data in the first on-vehicle communication device and a first decryption time that is a time required for decryption of data in the second on-vehicle communication device itself, and performs synchronization processing of carrying out time synchronization of the second on-vehicle communication device itself with the first on-vehicle communication device on the basis of the first encryption time and the first decryption time,

the first on-vehicle communication device and the second on-vehicle communication device are a switch device, a drive support ECU, a sensor, a body control ECU, or a body ECU,

the second on-vehicle communication device performs the synchronization processing on the basis of a mean time of a time required for transfer of data from the first on-vehicle communication device to the second on-vehicle communication device itself and a time required for transfer of data from the second on-vehicle communication device itself to the first on-vehicle communication device, and the first encryption time and the first decryption time, and

the second on-vehicle communication device does not acquire a time when the first on-vehicle communication device transmits encrypted data, and a time when the second on-vehicle communication device itself receives undecrypted data from the first on-vehicle communication device.

It is to be noted that, as used herein and in the appended claims, the singular forms “a”, “an”, and “the” include plural referents unless the context clearly dictates otherwise.
As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An on-vehicle communication device to be mounted on a vehicle, the on-vehicle communication device comprising:
a storage unit configured to store a first encryption time that is a time required for encryption of data in another on-vehicle communication device, and a first decryption time that is a time required for decryption of data in the on-vehicle communication device itself; and
a synchronization processing unit configured to perform synchronization processing of carrying out time synchronization of the on-vehicle communication device itself with the another on-vehicle communication device on the basis of the first encryption time and the first decryption time,
wherein the storage unit further stores a second encryption time that is a time required for encryption of data in the on-vehicle communication device itself, and a second decryption time that is a time required for decryption of data in the another on-vehicle communication device, and
the synchronization processing unit performs the synchronization processing on the basis of the first encryption time, the first decryption time, the second encryption time, and the second decryption time.

2-13. (canceled)

14. The on-vehicle communication device according to claim 1, wherein the storage unit stores the first encryption time and the first decryption time corresponding to size of data.

15. The on-vehicle communication device according to claim 1, wherein the storage unit stores the second encryption time and the second decryption time corresponding to size of data.

16. The on-vehicle communication device according to claim 1,
wherein the data to be transmitted from the another on-vehicle communication device to the on-vehicle communication device itself includes time information, and
the synchronization processing unit performs the synchronization processing on the basis of the time information included in the data received from the another on-vehicle communication device, and the first encryption time and the first decryption time.

17. The on-vehicle communication device according to claim 1, wherein any one of the another on-vehicle communication device and the on-vehicle communication device itself is a device configured to control equipment to be mounted on the vehicle.

18. The on-vehicle communication device according to claim 1, wherein any one of the another on-vehicle communication device and the on-vehicle communication device itself is a device configured to detect an object around the vehicle.

19. The on-vehicle communication device according to claim 1, wherein the data includes information for controlling equipment to be mounted on the vehicle.

20. The on-vehicle communication device according to claim 1, wherein the data includes information indicating a detection result of an object around the vehicle.

21. An on-vehicle communication system comprising:
a first on-vehicle communication device to be mounted on a vehicle; and
a second on-vehicle communication device to be mounted on the vehicle,
wherein the second on-vehicle communication device stores a first encryption time that is a time required for encryption of data in the first on-vehicle communication device and a first decryption time that is a time required for decryption of data in the second on-vehicle communication device itself, and performs synchronization processing of carrying out time synchronization of the second on-vehicle communication device itself with the first on-vehicle communication device on the basis of the first encryption time and the first decryption time, and
the second on-vehicle communication device further stores a second encryption time that is a time required for encryption of data in the second on-vehicle communication device itself, and a second decryption time that is a time required for decryption of data in the first on-vehicle communication device, and performs the synchronization processing on the basis of the first encryption time, the first decryption time, the second encryption time, and the second decryption time.

22. A synchronization processing method in an on-vehicle communication device, which is to be mounted on a vehicle and is provided with a storage unit configured to store a first encryption time that is a time required for encryption of data in another on-vehicle communication device and a first decryption time that is a time required for decryption of data in the on-vehicle communication device itself, the synchronization processing method including:
a step of acquiring the first encryption time and the first decryption time from the storage unit; and
a step of performing synchronization processing of carrying out time synchronization of the on-vehicle communication device itself with the another on-vehicle communication device on the basis of the acquired first encryption time and the acquired first decryption time,
wherein the storage unit further stores a second encryption time that is a time required for encryption of data in the on-vehicle communication device itself, and a second decryption time that is a time required for decryption of data in the another on-vehicle communication device, and
in the step of performing synchronization processing, performs the synchronization processing on the basis of the first encryption time, the first decryption time, the second encryption time, and the second decryption time.

23. A synchronization processing method in an on-vehicle communication system comprising a first on-vehicle communication device to be mounted on a vehicle and a second on-vehicle communication device to be mounted on the vehicle,
the second on-vehicle communication device storing a first encryption time that is a time required for encryption of data in the first on-vehicle communication device and a first decryption time that is a time required for decryption of data in the second on-vehicle communication device itself,
the synchronization processing method including:
a step of acquiring the first encryption time and the first decryption time by the second on-vehicle communication device; and
a step of performing synchronization processing of carrying out time synchronization of the second on-vehicle communication device itself with the first on-vehicle communication device by the second on-vehicle communication device on the basis of the acquired first encryption time and the acquired first decryption time,
the second on-vehicle communication device further stores a second encryption time that is a time required for encryption of data in the second on-vehicle communication device itself, and a second decryption time that is a time required for decryption of data in the first on-vehicle communication device, and
in the step of performing synchronization processing, the second on-vehicle communication device performs the synchronization processing on the basis of the first encryption time, the first decryption time, the second encryption time, and the second decryption time.

24. A computer readable non-transitory recording medium recording a synchronization processing program to be used in an on-vehicle communication device, which is to be mounted on a vehicle and comprises a storage unit configured to store a first encryption time that is a time required for encryption of data in another on-vehicle communication device and a first decryption time that is a time required for decryption of data in the on-vehicle communication device itself,
the synchronization processing program being capable of causing a computer to function as a synchronization processing unit configured to perform synchronization processing of carrying out time synchronization of the on-vehicle communication device itself with the another on-vehicle communication device on the basis of the first encryption time and the first decryption time,
wherein the storage unit further stores a second encryption time that is a time required for encryption of data in the on-vehicle communication device itself, and a second decryption time that is a time required for decryption of data in the another on-vehicle communication device, and
the synchronization processing unit performs the synchronization processing on the basis of the first encryption time, the first decryption time, the second encryption time, and the second decryption time.
